(19) United States
(12) Patent Application Publication
(10) Pub. No.: US 2025/0094019 A1
(43) Pub. Date: Mar. 20, 2025

(54) SPEECH TO TEXT TOUCHSCREEN GRAPHICS RENDERING

(71) Applicant: INTERNATIONAL BUSINESS MACHINES CORPORATION, ARMONK, NY (US)

(72) Inventors: Zachary A. Silverstein, Georgetown, TX (US); Logan Bailey, Atlanta, GA (US); Martin G. Keen, Cary, NC (US); Tiberiu Suto, Franklin, NY (US)

(21) Appl. No.: 18/467,925

(22) Filed: Sep. 15, 2023

(51) Int. Cl. G06F 3/0482; G06F 3/04817; G06F 3/04886; G06F 3/16; G10L 15/26

(52) U.S. Cl. CPC G06F 3/0482; G06F 3/04817; G06F 3/04886; G06F 3/167; G10L 15/26

(57) ABSTRACT

Described is a method for generating graphics in a user interface corresponding to options provided by an interactive voice response component by determining an interactive voice response (IVR) component is active on a call initiated by a user. The method identifying a various options provided by the IVR component with respect to a keypad in a user interface on a touchscreen of a device and displaying a graphic for each option from the various options provided by the IVR component. In response to receiving a graphic selection for the plurality options from a user, sending an option selection corresponding to the graphic selection to the IVR component.

### BACKGROUND

This disclosure relates generally to touchscreens, and in particular to rendering graphics into a user interface on a touchscreen based on speech to text processing for interactive voice response components.

An interactive voice response (IVR) is a technology that allows for a user of a mobile device to interact with a computer operated telephone system via speech and dual-tone multi-frequency signaling (DTMF) tones inputted via a keypad displayed in a user interface on a touchscreen of the mobile device. IVR systems utilize speech recognition and DTMF decoding to interpret the user's response to voice prompts and perform an action based on the user's response. IVR systems are utilized across various industries, such as, banking to assist with customer engagement or medical to conduct clinical trials and manage the large volume of data gather from the users engaging with the IVR. For the banking industry, customer interactions with the IVR systems are correlated to customer user experience and overall customer satisfaction with particular institutions in the banking industry.

### SUMMARY

Embodiments in accordance with the present invention disclose a method, computer program product and computer system for generating graphics in a user interface corresponding to options provided by an interactive voice response component, the method, computer program product and computer system can determine an interactive voice response (IVR) component is active. The method, computer program product and computer system can identify a plurality of options provided by the IVR component with respect to a keypad in a user interface on a touchscreen of a device. The method, computer program product and computer system can display a graphic for each option from the plurality of options provided by the IVR component. The method, computer program product and computer system can, responsive to receiving a graphic selection for the plurality options, send an option selection corresponding to the graphic selection to the IVR component.

### BRIEF DESCRIPTION OF THE SEVERAL VIEWS OF THE DRAWINGS

FIG. 1 is a functional block diagram illustrating a computing environment, in accordance with an embodiment of the present invention.

FIG. 2 depicts a flowchart for a touchscreen assistant program for generating graphics in a user interface corresponding to options provided by an interactive voice response (IVR) component, in accordance with an embodiment of the present invention.

FIG. 3A depicts an example user interface with a toggle for activating features of a touchscreen assistant program, in accordance with an embodiment of the present invention.

FIG. 3B depicts an example user interface displaying a first set of graphics generated by a touchscreen assistant program based on identified options from an IVR component, in accordance with an embodiment of the present invention.

FIG. 3C depicts an example user interface displaying graphics generated by a touchscreen assistant program based on identified options from an IVR component with a user selection, in accordance with an embodiment of the present invention.

FIG. 3D depicts an example user interface displaying a set of graphics generated by a touchscreen assistant program based on identified options from an IVR component resulting from a user selection, in accordance with an embodiment of the present invention.

FIG. 4A depicts an example ontology tree diagram generated by a touchscreen assistant program based on identified options from an IVR component, in accordance with an embodiment of the present invention.

FIG. 4B depicts an example ontology tree diagram generated by a touchscreen assistant program based on identified options from an IVR component with a user selection, in accordance with an embodiment of the present invention.

FIG. 5A depicts an example ontology tree diagram generated by a touchscreen assistant program based on identified options from an IVR component, in accordance with an embodiment of the present invention.

FIG. 5B depicts an example ontology tree diagram generated by a touchscreen assistant program based on identified options from an IVR component with multiple user selections, in accordance with an embodiment of the present invention.

FIG. 6A depicts an example of user interface for activating and displaying ontology tree diagram generated by a touchscreen assistant program based on identified options from an IVR component, in accordance with an embodiment of the present invention.

FIG. 6B depicts an example of a user interface for an ontology tree diagram generated by a touchscreen assistant program based on identified options from an IVR component with multiple user selections, in accordance with an embodiment of the present invention.

FIG. 7 depicts an example code snippet for a GAN model utilized by a touchscreen assistant program for generating graphics in a user interface corresponding to options provided by an IVR component, in accordance with an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments. It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

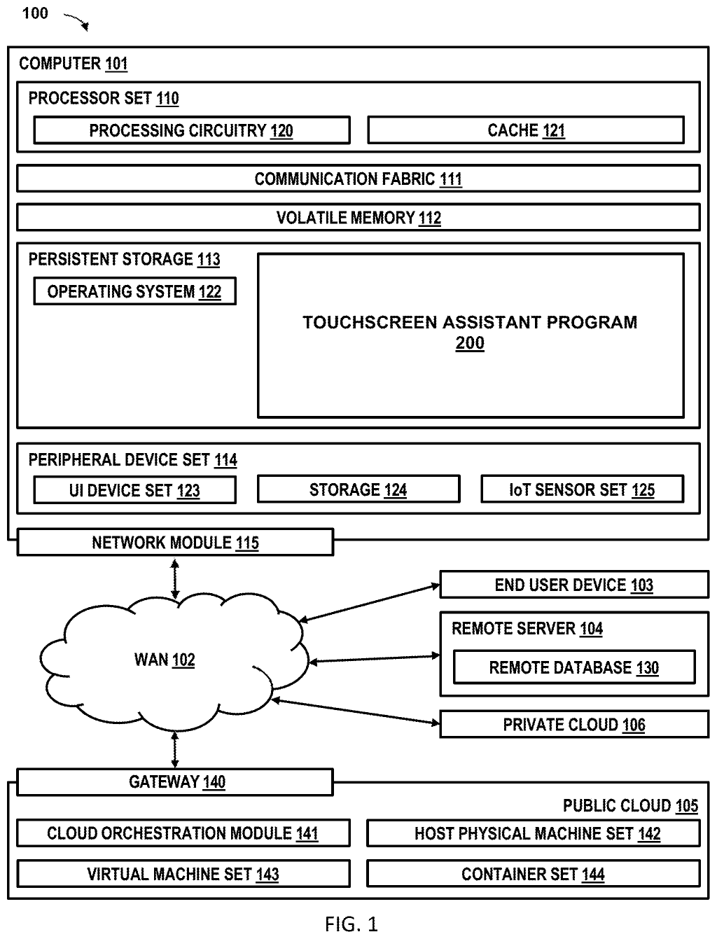

FIG. 1 is a functional block diagram illustrating a computing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 contains an example of an environment for the execution of at least some of the computer code involved in performing the inventive methods, such as, touchscreen assistant program 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

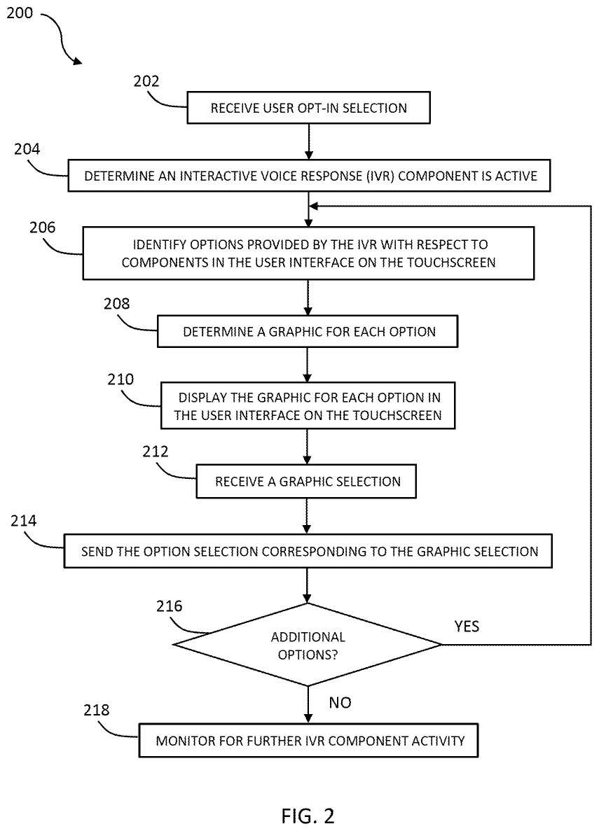

FIG. 2 depicts a flowchart for a touchscreen assistant program for generating graphics in a user interface corresponding to options provided by an interactive voice response (IVR) component, in accordance with an embodiment of the present invention.

Touchscreen assistant program 200 receives a user opt-in selection (202). Prior to a user with a device performing a call and engaging with an IVR component, the user can opt-in or opt-out of the utilization of one or more functions of touchscreen assistant program 200. Touchscreen assistant program 200 can display a user selectable feature in a user interface of the device being utilized by a user. The user selectable feature allows for the user to activate (i.e., opt-in) or deactivate (i.e., opt-out) the utilization of touchscreen assistant program 200 for generating graphics in the user interface corresponding to options provided by an IVR component. An example of a user selectable feature can include a toggle that touchscreen assistant program 200 displays in the user interface on a touchscreen of the device, where a movement of the toggle induced by the user activates or deactivates the one or more functions of touchscreen assistant program 200. In one embodiment, touchscreen assistant program 200 displays the user selectable feature in a vicinity of a keypad in the user interface on the touch screen of the device prior to the user performing the call and engaging with the IVR component. In response to receiving an input for the user selectable feature (i.e., the user opt-in selection), touchscreen assistant program 200 determines to activate the one or more functions for generating graphics in the user interface corresponding to options provided by an IVR component. In another embodiment, touchscreen assistant program 200 determines the user has initiated a call and determines an IVR component is audibly present for a dialed number. In response to touchscreen assistant program 200 determining the IVR component is audibly present, touchscreen assistant program 200 displays the user selectable feature in a vicinity of a keypad in the user interface om the touch screen of the device. In response to receiving an input for the user selectable feature (i.e., the user opt-in selection), touchscreen assistant program 200 determines to activate the one or more functions for generating graphics in the user interface corresponding to options provided by an IVR component.

Touchscreen assistant program 200 determines an IVR component is active (204). In one embodiment, touchscreen assistant program 200 determines an IVR component is active for a dialed number utilizing a combination of cosine similarity and word2vec processing of incoming audio to determine structure of the IVR dialogue to identify statements and options provided by the IVR component. In one example, touchscreen assistant program 200 utilizes cosine similarity and word2vec processing to identify a statement regarding a language selection is present and determines an IVR component is active. In another embodiment, touchscreen assistant program 200 determines an IVR component is active for a dialed number utilizing a recurrent neural network (RNN) that has been previously trained on the sounds of IVR options. Touchscreen assistant program 200 can be trained by inputting various IVR options and subsequently utilizing RNN to correspond current incoming audio to the various IVR options provided during the training. In certain instances, touchscreen assistant program 200 can require user input to manually initiate monitoring to ensure that only relevant IVR lines are being monitored. As previously discussed, this user input to manual initiate monitoring is performed via the user selectable feature in the user interface on the touchscreen of the device. In yet another embodiment, touchscreen assistant program 200 maintains a repository of numbers dialed by various users for which an IVR component was detected. In response to touchscreen assistant program 200 detecting a number dialed by the user is not present in the repository, touchscreen assistant program 200 determines if an IVR component is active based on the incoming audio. In response to determining an IVR component is active, touchscreen assistant program 200 updates the repository of numbers with the current dialed number and an indication that an IVR component is present.

Touchscreen assistant program 200 identifies options provided by the IVR with respect to components in the user interface on the touchscreen (206). Touchscreen assistant program 200 identifies each option provided by the IVR component and associates each option with a component in the user interface on the touchscreen of the device. Touchscreen assistant program 200 identifies options provided by the IVR component by utilizing one or more text processing algorithms, such as, speech-to-text to capture the incoming audio and parameterize (i.e., transform) the incoming audio into text-based format. With the text-based format for the options provided by the incoming audio from the IVR, touchscreen assistant program 200 identifies which components in the user interface on the touchscreen of the device correspond to the options. Typically, a single option provided by the IVR component is associated a single component in the user interface on the touchscreen, where the single component is associated with a keypad. In one example, touchscreen assistant program 200 receives the incoming audio from an IVR component and parameterizes the incoming audio into a text-based format that states, “For checking account balance, please present one”. From the text-based format, touchscreen assistant program 200 identifies an option for obtaining a checking account balance provided by the IVR component with a number one entry on a keypad (e.g., component) in the user interface on the touchscreen.

Touchscreen assistant program 200 determines a graphic for each option (208). Touchscreen assistant program 200 can utilize one or more methods for determining a graphic for displaying each option in the user interface on the touchscreen of the device, where the methods include a generative adversarial network (GAN), a repository of generic images, and a repository of personalized images. The GAN is a type of neural network utilized for generating images on a given input and consists of two components, a generator and a discriminator. The generator is responsible for creating an image based on input and the discriminator is responsible for determining if the image is realistic enough to be considered a valid image. The two components of the GAN operate in an adversarial manner, where the discriminator is constantly trying to identify and reject images that are not realistic enough while the generator is constantly trying to create images that are realistic to overcome the discriminator. The GAN for touchscreen assistant program 200 is trainable utilizing a repository of images that are associated with the input text, thus allowing the GAN to generate realistic images for each of the options. Touchscreen assistant program 200 can utilize GAN to generate an image based on the incoming audio for each option provided by the IVR for displaying in the user interface on the touchscreen of the device.

Touchscreen assistant program 200 can also utilize a repository of generic images, such as, clipart or stock images for each option provided by the IVR for displaying in the user interface on the touchscreen of the device. In one example, touchscreen assistant program 200 identifies an option provided by the IVR with respect to components in the user interface on the touch screen includes accessing a checking account by pressing the numerical value 3 on the keypad, touchscreen assistant program 200 determines a graphic illustrating (i.e., representing) a checking account. Touchscreen assistant program 200 utilizes the repository of generic images and identifies an image of a banking check for displaying in the user interface on the touchscreen of the device. In another example, touchscreen assistant program 200 identifies an option provided by the IVR with respect to components in the user interface on the touch screen includes talking to a customer service representative by pressing the numerical value 9 on the keypad, touchscreen assistant program 200 determines a graphic to illustrate a customer service representative. Touchscreen assistant program 200 utilizes the repository of generic images and identifies an image of a generic individual wearing a communication headset for displaying in the user interface on the touchscreen of the device.

Touchscreen assistant program 200 can also utilize a repository of personalized images, where a user can provide images and feedback for personalized graphics. Touchscreen assistant program 200 can determine a graphic for each option utilizing a generic image stored in the repository and subsequent to completion of a call with the IVR component, touchscreen assistant program 200 can request feedback for the generic image. In response to receiving an indication from the user that the generic image was not an accurate representation of the option, touchscreen assistant program 200 can utilize another generic image for a subsequent call, where the subsequent call includes an IVR component that provides a similar or identical option to the user. Alternatively, in response to receiving an indication from the user that the generic image was not an accurate representation of the option, touchscreen assistant program 200 can receive an image from the user for utilization in a subsequent call, where the subsequent call includes an IVR component that provides a similar or identical option to the user. Touchscreen assistant program 200 can receive the image via a hyperlink to the image or via an image file from the device (e.g., photo library). Touchscreen assistant program 200 stores the image and an association of the option provided by the IVR component in the repository of personalized images and continuously updates the repository of personalized images as more images are received from the user via user feedback.

Touchscreen assistant program 200 displays the graphic for each option in the user interface on the touchscreen (210). In one embodiment, touchscreen assistant program 200 displays the graphic for each option as an overlay on top of each corresponding key on a keypad in the user interface on the touchscreen of the device. In another embodiment, touchscreen assistant program 200 displays the graphic for each option in place of each corresponding key on a keypad in the user interface on the touchscreen of the device. For either embodiment, touchscreen assistant program 200 can provide text or other text summarization to further guide the user. For example, as touchscreen assistant program 200 displays the graphic for each option in the user interface on the touchscreen, touchscreen assistant program 200 can allow for the user to utilize a specific input (e.g., two finger press and hold, one finger extended press and hold) to display the text for the option that touchscreen assistant program 200 displays as a graphic in the user interface on the touchscreen. Touchscreen assistant program 200 can temporarily display the text as a ribbon and/or overlay for the option in the user interface on the touch screen. For example, touchscreen assistant program 200 can temporarily display the text for the option as a ribbon at the top of the user interface on the touch screen, where the ribbon does not obscure the keypad and the graphics that touchscreen assistant program 200 displays for all of the options. Touchscreen assistant program 200 can utilize a combination of technologies such as, HTML, CSS, and JavaScript™ to render and display the graphics. Touchscreen assistant program 200 can also utilize streaming technologies such as, MPEG-DASH to ensure the graphics are correctly displayed in the user interface on the touchscreen. Furthermore, touchscreen assistant program 200 can utilizes image optimization algorithms such as, JPEG and PNG optimization to reduce the size of the images and ensure the graphics are correctly displayed in the user interface on the touchscreen.

Touchscreen assistant program 200 receives a graphic selection (212). The graphic selection includes a user utilizing a finger to press (i.e., select) a graphic corresponding to a desired option provided the IVR component. Touchscreen assistant program 200 receives the graphic selection by the user pressing the graphic for the desired option. In one embodiment, where touchscreen assistant program 200 replaces a specific key (e.g., key for numerical value 9) on the keypad with the corresponding graphic for an option (e.g., image of a generic individual wearing a communication headset), touchscreen assistant program 200 receives the graphic selection and temporarily highlights the graphic selection to indicate the selection for the desired option was received. In another embodiment, where touchscreen assistant program 200 overlays a graphic for an option (e.g., an image of banking check) over a corresponding key on the keypad (e.g., key for numerical value 3), touchscreen assistant program 200 receives the graphic selection and temporarily highlights both the graphic selection and a visible portion of the corresponding key on the keypad to indicate the selection for the desired option was received.

Touchscreen assistant program 200 sends the option selection corresponding to the graphic selection (214). In this embodiment, touchscreen assistant program 200 converts the received graphic selection into a key selection on the keypad and performs the key selection on the keypad, where performing the key selection on the keypad represents touchscreen assistant program 200 sending the option corresponding to the graphic selection to the IVR component. Since a typical IVR component utilizes dual tone multi frequency (DTMF) to identify a key selection on the keypad, touchscreen assistant program 200 performs the key selection on the keypad based on the received graphic selection from (212). In another embodiment, touchscreen assistant program 200 converts the received graphic selection into a desired key selection on the keypad and generates an audible response corresponding to the desired key selection (e.g., “one” or “pound”), where touchscreen assistant program 200 sends the audible response for the desired key selection to the IVR component.

Touchscreen assistant program 200 determines whether there are additional options provided by the IVR (decision 216). Since an IVR component provides options to the user in tiers or levels, touchscreen assistant program 200 determines where there is another tier or level of additional options, subsequent to sending the option corresponding to the graphic selection. In the event touchscreen assistant program 200 determines there are additional options provided by the IVR (“yes” branch, decision 216), touchscreen assistant program 200 reverts to identifying the options provided by the IVR with respect to components in the user interface on the touchscreen (206). In the event touchscreen assistant program 200 determines there are no additional options provided by the IVR (“no” branch, decision 216), touchscreen assistant program 200 monitors for further IVR component activity (218). As long as the current call active and the user opt-in selection is activated, touchscreen assistant program 200 monitors the incoming audio for further IVR component activity.

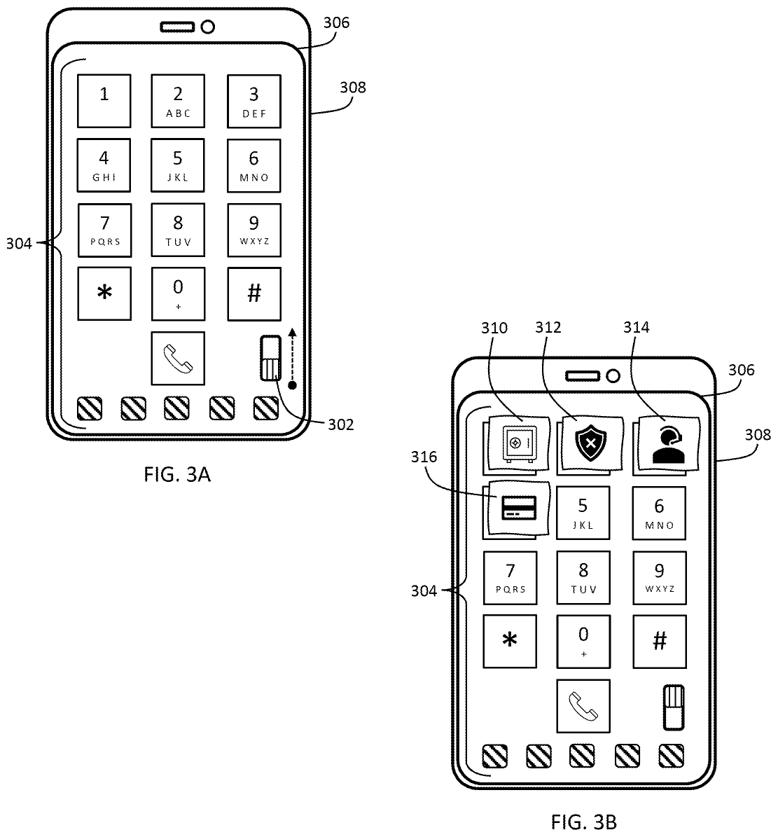

FIG. 3A depicts an example user interface with a toggle for activating features of a touchscreen assistant program, in accordance with an embodiment of the present invention. In this embodiment, touchscreen assistant program 200 displays a user selectable feature as toggle 302 in user interface 304 on touchscreen 306 of mobile device 308. The user selectable feature represented as toggle 302 allows for the user of mobile device 308 to activate (i.e., opt-in) or deactivate (i.e., opt-out) the utilization of touchscreen assistant program 200 for generating graphics in user interface 304 corresponding to options provided by an IVR component. The arrow indicates a movement of toggle 302 for activating one or more functions of touchscreen assistant program 200, where a user input to slide toggle 302 upwards represents touchscreen assistant program 200 receiving a user-op-in selection to activate the one or more functions for generating graphics in user interface 304 corresponding to options provided by an IVR component.

FIG. 3B depicts an example user interface displaying a first set of graphics generated by a touchscreen assistant program based on identified options from an IVR component, in accordance with an embodiment of the present invention. As a user of mobile device 308 performs a call, touchscreen assistant program 200 determines an IVR component is active based on incoming audio. Touchscreen assistant program 200 identifies options provided by the IVR component with respect to components in user interface 304 on touchscreen 306 and determines a graphic for each option. In this embodiment, the components in user interface 304 are individual keys of a keypad utilized by the user of mobile device 308 to dial a number and engage with the IVR component with physical inputs (i.e., keypad entries). Based on the incoming audio from the IVR component, touchscreen assistant program 200 identifies e-banking options are associated with individual key value 1 of the keypad, fraud related options are associated with individual key value 2 of the keypad, speak with a customer service representative option is associated with individual key value 3 of the keypad, and credit card account options are associated with individual key value 4 of the keypad. For each of the four options that touchscreen assistant program 200 identifies, touchscreen assistant program 200 determines graphic 310 for the e-banking options associated with individual key value 1 of the keypad, graphic 312 for the fraud related options associated with individual key value 2 of the keypad, graphic 314 to speak with a customer service representative option associated with individual key value 3 of the keypad, and graphic 316 for the credit card account options associated with individual key value 4 of the keypad. Touchscreen assistant program 200 displays graphics 310, 312, 314, and 316 for the four options provided by the IVR component.

FIG. 3C depicts an example user interface displaying graphics generated by a touchscreen assistant program based on identified options from an IVR component with a user selection, in accordance with an embodiment of the present invention. In this embodiment, touchscreen assistant program 200 receives selection 318 of graphic 314 in user interface 304, where graphic 314 is for the option to speak with a customer service representative associated with individual key value 3 of the keypad. Touchscreen assistant program 200 receives selection 318 via physical input by the user on touchscreen 306 of mobile device 308. Touchscreen assistant program 200 converts selection 318 into a key selection on the keypad and performs the key selection on the keypad, where performing the key selection on the keypad represents touchscreen assistant program 200 sending the option corresponding to selection 318 to the IVR component. In this embodiment, the key selection represents the pressing of the individual key value 3 of the keypad.

FIG. 3D depicts an example user interface displaying a set of graphics generated by a touchscreen assistant program based on identified options from an IVR component resulting from a user selection, in accordance with an embodiment of the present invention. In this embodiment, touchscreen assistant program 200 determines there are additional options provided by the IVR component and touchscreen assistant program 200 identifies options provided by the IVR component with respect to components in user interface 304 on touchscreen 306 and determines a graphic for each option. Based on the incoming audio from the IVR component, touchscreen assistant program 200 identifies a continue to hold for the next available customer service representative option is associated with individual key value 1 of the keypad and receive a call-back from the next available customer service representative option is associated with individual key value 2 of the keypad. For each of the two options that touchscreen assistant program 200 identifies, touchscreen assistant program 200 determines graphic 320 for the continue to hold for the next available customer service representative option associated with individual key value 1 of the keypad and graphic 322 for the receive a call-back from the next available customer service representative option associated with individual key value 2 of the keypad. In this embodiment, the user of mobile device 308 is not familiar with graphic 322 and therefore, touchscreen assistant program 200 receives a specific user input from the user (e.g., two finger press and hold) via touchscreen 306, where the specific user input is associated with displaying text summarizing the option associated with graphic 322. Touchscreen assistant program 200 displays text for option summary 324 associated with graphic 322 as a ribbon in user interface 304 on touchscreen 306.

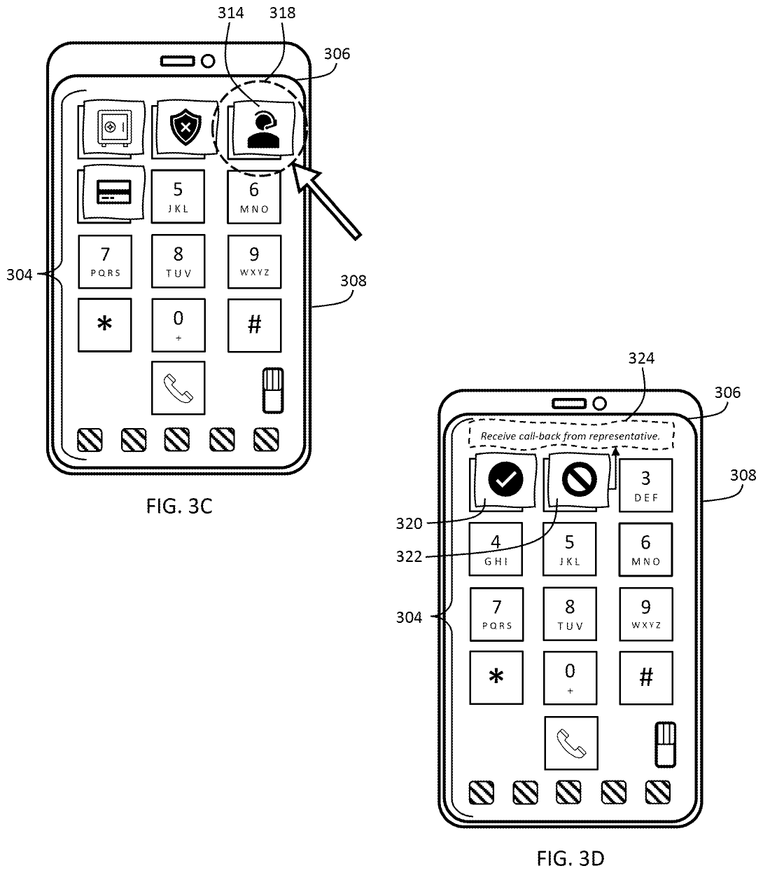

FIG. 4A depicts an example ontology tree diagram generated by a touchscreen assistant program based on identified options from an IVR component, in accordance with an embodiment of the present invention. In some embodiments, touchscreen assistant program 200 can initiate a request to the IVR component utilizing a specific user input (e.g., special key sequence), where touchscreen assistant program 200 sends a request to the IVR component for all available IVR option pathways across all tiers or levels. Touchscreen assistant program 200 can receive the all the available IVR option pathways in the form on an encoded ontology tree, where touchscreen assistant program 200 displays the ontology tree in a user interface on a touchscreen. In this embodiment, a portion of the ontology tree for the available IVR option pathways is illustrated, where selecting an e-banking option via a selection of an individual key value 1 on the keypad leads to another tier or level of options. The other tier or level of options includes mobile banking option associated with individual key value 1 on the keypad and bill pay option associated with individual key value 2.

FIG. 4B depicts an example ontology tree diagram generated by a touchscreen assistant program based on identified options from an IVR component with a user selection, in accordance with an embodiment of the present invention. In this embodiment, if a user is attempting to access bill pay via the IVR component, touchscreen assistant program 200 can receive a selection of (2) bill pay positioned on a second tier or level via the user interface on the touch screen. Touchscreen assistant program 200 can generate a sequence code of, “1, 2” for input into the IVR component to direct the user to the desired selection without having the user to take the time to listen to the incoming audio from the IVR component for each of the options across the two tiers or levels of options. Touchscreen assistant program 200 converts the received selection of (2) bill pay and performs the key selection on the keypad for the sequence code, where performing the key selection on the keypad for the sequence code represents touchscreen assistant program 200 sending the option of “1” followed by “2” corresponding to the selection of (2) bill pay to the IVR component.

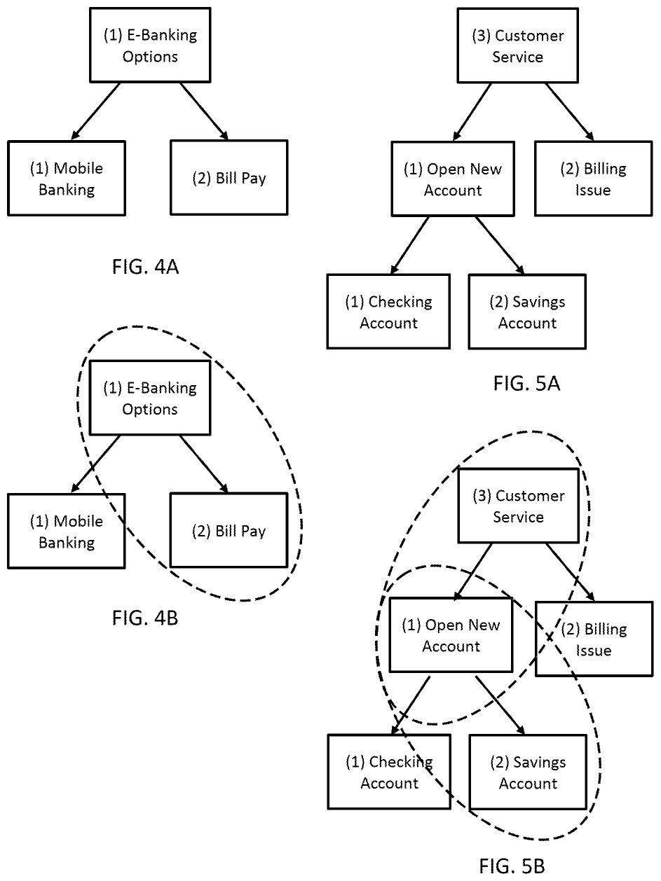

FIG. 5A depicts an example ontology tree diagram generated by a touchscreen assistant program based on identified options from an IVR component, in accordance with an embodiment of the present invention. In this embodiment, a portion of the ontology tree for the available IVR option pathways is illustrated, where selecting a customer service option via a selection of an individual key value 3 on the keypad leads to another tier or level of options. The other tier or level of options includes an open new account option associated with individual key value 1 on the keypad and a billing issue option associated with individual key value 2. Selecting the open new account option via a selection of an individual key value 1 on the keypad leads to yet another tier or level of options. The yet another tier or level of options includes a checking account option associated with individual key value 1 on the keypad and a savings account option associated with individual key value 2.

FIG. 5B depicts an example ontology tree diagram generated by a touchscreen assistant program based on identified options from an IVR component with multiple user selections, in accordance with an embodiment of the present invention. In this embodiment, a user is attempting to open a new savings account via the IVR component, touchscreen assistant program 200 can receive a selection of (2) savings account positioned on a third tier or level in the ontology tree via the user interface on the touch screen. Touchscreen assistant program 200 can generate a sequence code of, “3, 1, 2” for input into the IVR component to direct the user to the desired selection without having the user to take the time to listen to the incoming audio from the IVR component for each of the options across the three tiers or levels of options. Touchscreen assistant program 200 converts the received selection of (2) savings account and performs the key selection on the keypad for the sequence code, where performing the key selection on the keypad for the sequence code represents touchscreen assistant program 200 sending the option of “3” followed by “1” and following by “2” corresponding to the selection of (2) savings account to the IVR component. In another embodiment, touchscreen assistant program 200 can receive a selection via a user dragging their finger across the ontology tree, where touchscreen assistant program 200 transforms a path created by the user input into the generated sequence code of “3, 1, 2”.

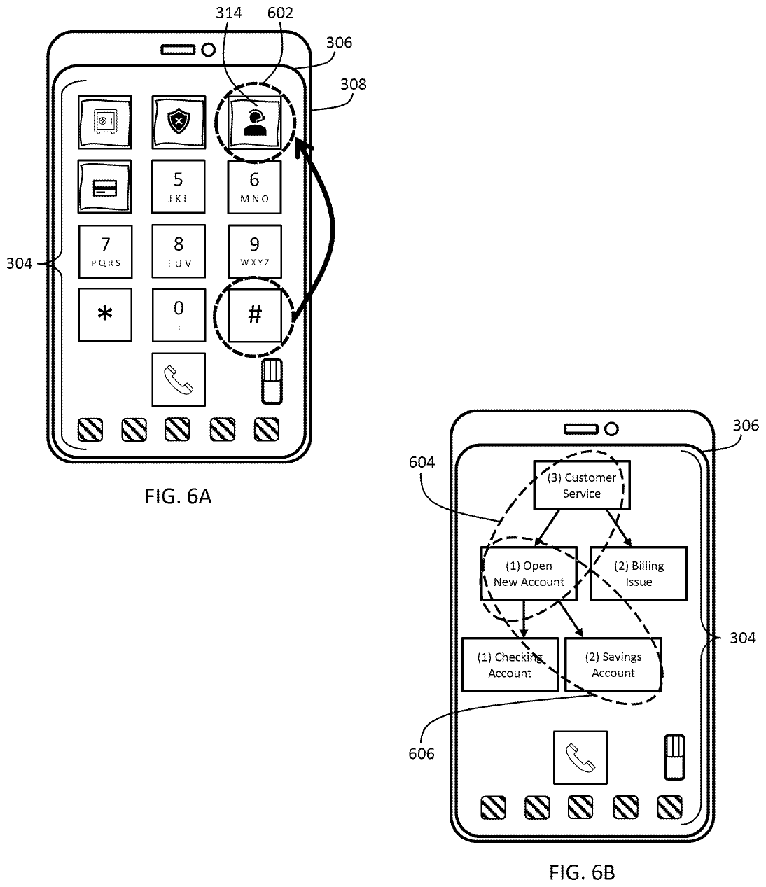

FIG. 6A depicts an example of user interface for activating and displaying ontology tree diagram generated by a touchscreen assistant program based on identified options from an IVR component, in accordance with an embodiment of the present invention. As a user of mobile device 308 performs a call, touchscreen assistant program 200 determines an IVR component is active based on incoming audio. Touchscreen assistant program 200 identifies options provided by the IVR component with respect to components in user interface 304 on touchscreen 306 and determines a graphic for each option. In this embodiment, a user of touchscreen assistant program 200 would like to view the ontology tree for selecting graphic 314 in user interface 304, where graphic 314 is for the option to speak with a customer service representative associated with individual key value 3 of the keypad. To display the ontology tree for selecting graphic 314, touchscreen assistant program 200 receives a specific user input associated with displaying the ontology tree in user interface 304 on touchscreen 306. The specific user input includes the user selecting the “#” key on the keypad prior to selecting graphic 314. Touchscreen assistant program 200 receives the specific input of the “#” key followed by selection 602 of graphic 314 in user interface 304 via physical input by the user on touchscreen 306 of mobile device 308. Touchscreen assistant program 200 converts the specific input of the “#” key and selection 602 into a key selection on the keypad and performs the key selection on the keypad, where performing the key selection on the keypad represents touchscreen assistant program 200 sending the option corresponding to the “#” key and selection 602 to the IVR component to obtain the ontology tree.

FIG. 6B depicts an example of a user interface for an ontology tree diagram generated by a touchscreen assistant program based on identified options from an IVR component with multiple user selections, in accordance with an embodiment of the present invention. In this embodiment, a user is attempting to open a new savings account via the IVR component, touchscreen assistant program 200 receives a selection of (2) savings account in the ontology tree via user interface 304 on touchscreen 306. Touchscreen assistant program 200 can generate a sequence code of, “3, 1, 2” for input into the IVR component to direct the user to the desired selection without having the user to take the time to listen to the incoming audio from the IVR component for each of the options across the three tiers or levels of options. Touchscreen assistant program 200 converts the received selection of (2) savings account and performs the key selection on the keypad for the sequence code, where performing the key selection on the keypad for the sequence code represents touchscreen assistant program 200 sending the option of “3” followed by “1” and following by “2” corresponding to the selection of (2) savings account to the IVR component. In another embodiment, touchscreen assistant program 200 can receive a selection via a user dragging their finger across the ontology tree creating path 604 following by path 606, where touchscreen assistant program 200 transforms path 604 and 606 into the generated sequence code of “3, 1, 2”.

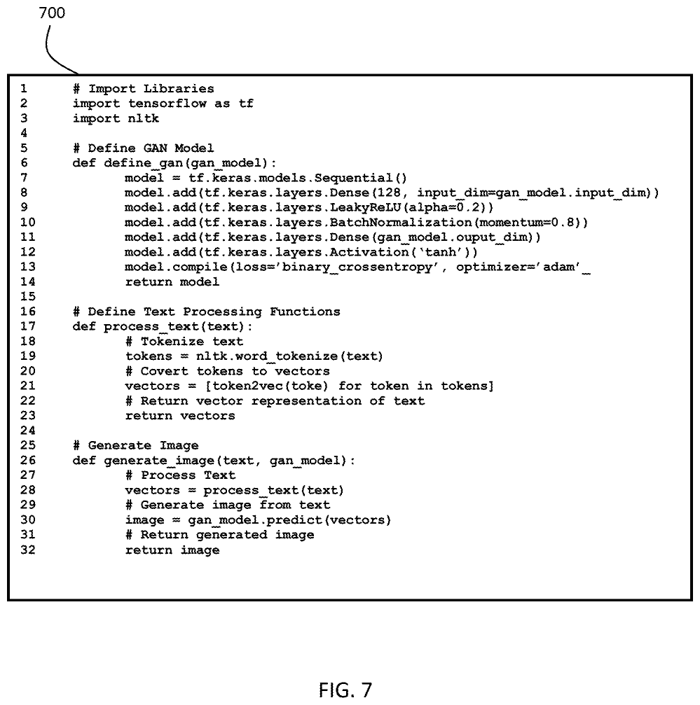

FIG. 7 depicts an example code snippet for a GAN model utilized by a touchscreen assistant program for generating graphics in a user interface corresponding to options provided by an IVR component, in accordance with an embodiment of the present invention. Code snippet 700 is an example of how touchscreen assistant program 200 utilizes a GAN model to generate an image from a given input. Initially, touchscreen assistant program 200 receives as an import any necessary libraries for the GAN model and for the processing of any text input. The GAN model and the text functions are defined, where the GAN model of touchscreen assistant program 200 is utilized to generate an image (i.e., a graphic) from the given input text for a specific option provided by the IVR component. Touchscreen assistant program 200 tokenizes the text and converts each token to a vector representation. touchscreen assistant program 200 inputs the vector representation into the GAN model, which results in an image being generated for the text and returned for displaying as a graphic for an option in the user interface on the touchscreen.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining an interactive voice response (IVR) component is active;
identifying a plurality of options provided by the IVR component with respect to a keypad in a user interface on a touchscreen of a device;
displaying a graphic for each option from the plurality of options provided by the IVR component; and
responsive to receiving a graphic selection for the plurality options, sending an option selection corresponding to the graphic selection to the IVR component.

2. The computer-implemented method of claim 1, further comprising:
receiving a user opt-in selection via a user selectable feature in the user interface, wherein the user opt-in selection displays the graphic for each option from the plurality options provided by the IVR component.

3. The computer-implemented method of claim 1, wherein sending the option selection corresponding to the graphic selection to the IVR component further comprises:
converting the graphic selection into a key selection on the keypad in the user interface; and
performing the key selection on the keypad in the user interface.

4. The computer-implemented method of claim 1, further comprising:
determining the graphic for each option from the plurality of options provided by the IVR component utilizing a generative adversarial network (GAN) model to generate an image for the graphic for each option from the plurality options based on incoming audio from the IVR component.

5. The computer-implemented method of claim 1, further comprising:
responsive to receiving a specific user input via the keypad in the user interface, sending a request to the IVR component for available IVR option pathways across a plurality of tiers with the plurality of options; and
responsive to receiving the available IVR option pathways from IVR component, displaying an ontology tree for the plurality of tiers with the plurality of options in the user interface for the graphic selection.

6. The computer-implemented method of claim 5, further comprising:
receiving the graphic selection for an option from the plurality options via the ontology tree in the user interface, wherein the option is positioned on a tier that is not a first tier in the ontology tree.

7. The computer-implemented method of claim 1, further comprising:
responsive to receiving a specific user input via the keypad in the user interface, displaying a summary of an option from the plurality of options for a specific graphic associated with a specific key on the keypad.

8. A computer program product comprising:
one or more computer-readable storage media;
program instructions, stored on at least one of the one or more storage media, to determine an interactive voice response (IVR) component is active;
program instructions, stored on at least one of the one or more storage media, to identify a plurality of options provided by the IVR component with respect to a keypad in a user interface on a touchscreen of a device;
program instructions, stored on at least one of the one or more storage media, to display a graphic for each option from the plurality of options provided by the IVR component; and
program instructions, stored on at least one of the one or more storage media, responsive to receiving a graphic selection for the plurality options, to send an option selection corresponding to the graphic selection to the IVR component.

9. The computer program product of claim 8, further comprising:
program instructions, stored on at least one of the one or more storage media, to receive a user opt-in selection via a user selectable feature in the user interface, wherein the user opt-in selection displays the graphic for each option from the plurality options provided by the IVR component.

10. The computer program product of claim 8, wherein program instructions, stored on at least one of the one or more storage media, to send the option selection corresponding to the graphic selection to the IVR component further comprises:
program instructions, stored on at least one of the one or more storage media, to convert the graphic selection into a key selection on the keypad in the user interface; and
program instructions, stored on at least one of the one or more storage media, to perform the key selection on the keypad in the user interface.

11. The computer program product of claim 8, further comprising:
program instructions, stored on at least one of the one or more storage media, to determine the graphic for each option from the plurality of options provided by the IVR component utilizing a generative adversarial network (GAN) model to generate an image for the graphic for each option from the plurality options based on incoming audio from the IVR component.

12. The computer program product of claim 8, further comprising:
program instructions, stored on at least one of the one or more storage media, responsive to receiving a specific user input via the keypad in the user interface, to send a request to the IVR component for available IVR option pathways across a plurality of tiers with the plurality of options; and
program instructions, stored on at least one of the one or more storage media, responsive to receiving the available IVR option pathways from IVR component, to display an ontology tree for the plurality of tiers with the plurality of options in the user interface for the graphic selection.

13. The computer program product of claim 12, further comprising:
program instructions, stored on at least one of the one or more storage media, to receiving the graphic selection for an option from the plurality options via the ontology tree in the user interface, wherein the option is positioned on a tier that is not a first tier in the ontology tree.

14. The computer program product of claim 8, further comprising:
program instructions, stored on at least one of the one or more storage media, responsive to receiving a specific user input via the keypad in the user interface, to display a summary of an option from the plurality of options for a specific graphic associated with a specific key on the keypad.

15. A computer system comprising:
one or more processors, one or more computer-readable memories and one or more computer-readable storage media;
program instructions, stored on at least one of the one or more storage media for execution by at least one of the one or more processors via at least one of the one or more memories, to determine an interactive voice response (IVR) component is active;
program instructions, stored on at least one of the one or more storage media for execution by at least one of the one or more processors via at least one of the one or more memories, to identify a plurality of options provided by the IVR component with respect to a keypad in a user interface on a touchscreen of a device;
program instructions, stored on at least one of the one or more storage media for execution by at least one of the one or more processors via at least one of the one or more memories, to display a graphic for each option from the plurality of options provided by the IVR component; and
program instructions, stored on at least one of the one or more storage media for execution by at least one of the one or more processors via at least one of the one or more memories, responsive to receiving a graphic selection for the plurality options, to send an option selection corresponding to the graphic selection to the IVR component.

16. The computer system of claim 15, further comprising:
program instructions, stored on at least one of the one or more storage media for execution by at least one of the one or more processors via at least one of the one or more memories, to receive a user opt-in selection via a user selectable feature in the user interface, wherein the user opt-in selection displays the graphic for each option from the plurality options provided by the IVR component.

17. The computer system of claim 15, wherein program instructions, stored on at least one of the one or more storage media for execution by at least one of the one or more processors via at least one of the one or more memories, to send the option selection corresponding to the graphic selection to the IVR component further comprises:
program instructions, stored on at least one of the one or more storage media for execution by at least one of the one or more processors via at least one of the one or more memories, to convert the graphic selection into a key selection on the keypad in the user interface; and
program instructions, stored on at least one of the one or more storage media for execution by at least one of the one or more processors via at least one of the one or more memories, to perform the key selection on the keypad in the user interface.

18. The computer system of claim 15, further comprising:
program instructions, stored on at least one of the one or more storage media for execution by at least one of the one or more processors via at least one of the one or more memories, to determine the graphic for each option from the plurality of options provided by the IVR component utilizing a generative adversarial network (GAN) model to generate an image for the graphic for each option from the plurality options based on incoming audio from the IVR component.

19. The computer system of claim 15, further comprising:
program instructions, stored on at least one of the one or more storage media for execution by at least one of the one or more processors via at least one of the one or more memories, responsive to receiving a specific user input via the keypad in the user interface, to send a request to the IVR component for available IVR option pathways across a plurality of tiers with the plurality of options; and
program instructions, stored on at least one of the one or more storage media for execution by at least one of the one or more processors via at least one of the one or more memories, responsive to receiving the available IVR option pathways from IVR component, to display an ontology tree for the plurality of tiers with the plurality of options in the user interface for the graphic selection.

20. The computer system of claim 19, further comprising:
program instructions, stored on at least one of the one or more storage media for execution by at least one of the one or more processors via at least one of the one or more memories, to receive the graphic selection for an option from the plurality options via the ontology tree in the user interface, wherein the option is positioned on a tier that is not a first tier in the ontology tree.
